(19) United States
(12) Patent Application Publication
(10) Pub. No.: US 2015/0321937 A1
(43) Pub. Date: Nov. 12, 2015

(54) METHOD AND SYSTEM FOR TREATING WASTEWATER IN AN INTEGRATED FIXED FILM ACTIVATED SLUDGE SEQUENCING BATCH REACTOR

(71) Applicant: Veolia Water Solutions & Technologies Support, Saint-Maurice (FR)

(72) Inventors: Hong W. Zhao, Raleigh, NC (US); Michael Leon Gutshall, Holly Springs, NC (US); Glenn Thesing, Pittsboro, NC (US); Richard W. DiMassimo, Raleigh, NC (US); Magnus Christensson, Lund (SE)

(73) Assignee: VEOLIA WATER SOLUTIONS & TECHNOLOGIES SUPPORT, Saint-Maurice (FR)

(21) Appl. No.: 14/271,579

(22) Filed: May 7, 2014

(51) Int. Cl. C02F 11/04

(52) U.S. Cl. CPC C02F 11/04

(57) ABSTRACT

An integrated fixed film activated sludge sequencing batch reactor is provided where both suspended biomass and biomass supported on biofilm carriers are utilized to biologically treat wastewater received by the sequencing batch reactor. The sequencing batch reactor includes two hydraulically connected tanks with suspended biomass being contained in at least one tank and biomass supported on biofilm carriers in the other tank.

### FIELD OF THE INVENTION

The present invention relates to a system and process for treating wastewater, and more particularly to an integrated fixed film activated sludge sequencing batch reactor system and processes.

### BACKGROUND OF THE INVENTION

Sequencing batch reactors (SBRs) have been employed in wastewater treatment since the 1920s, and now are used throughout the world. SBRs are widely used in the United States, China and Europe to treat both municipal and industrial wastewaters. They are especially practical in applications having low or varying flow patterns. There are other characteristics of SBRs that make them a viable option in certain cases. For example, where there is a limited amount of space, an SBR offers the opportunity to treat wastewater in a single tank, instead of multiple tanks. This enables wastewater treatment systems to be constructed on a relatively small footprint. In addition, SBRs can be controlled to provide aerobic, anaerobic and anoxic conditions in order to achieve biological nutrient removal including nitrification/de-nitrification, nitrification only and, in some cases, phosphorus removal. Biochemical oxygen demand (BOD) can be removed to relatively low levels. SBRs are efficient in removing total nitrogen down to as low as 5 mg/L. This is achieved by employing aerobic conditions to convert ammonia to nitrate and nitrite (nitrification) and anoxic treatment of the nitrate and nitrite to yield nitrogen gas (de-nitrification). All of this can be achieved in the same tank. In some cases, SBRs can be employed to reduce phosphorus concentrations down to less than 2 mg/L by employing anaerobic treatment.

SBRs are a variation of the conventional activated sludge process. They differ from activated sludge plants in that SBRs combine the treatment steps and processes into typically a single basin or tank, whereas conventional activated sludge processes rely on multiple tanks. An SBR typically includes four different steps or phases: (1) fill, (2) react, (3) settle and (4) decant. During the fill phase, the tank receives influent wastewater. Influent delivers food to the microorganisms in the activated sludge and creates an environment for biochemical reactions to take place. During the fill operation, the wastewater can be mixed and/or aerated.

During the react or reaction phase, the biomass or bacteria in the wastewater consumes nutrients. In one example, the SBR in the react phase is operated under aerobic conditions. Here the biomass performs a nitrification process by converting ammonia to nitrite and nitrate. In this process, the wastewater is aerated and mixed. The addition of oxygen to the wastewater encourages the multiplication of aerobic bacteria.

The settling stage or phase follows the react phase. During this stage, the sludge formed by the bacteria is allowed to settle to the bottom of the tank. Generally, the aerobic bacteria continue to multiply until the dissolved oxygen is consumed. As the bacteria multiply and die, the sludge within the tank increases over time and a waste-activated sludge pump removes some of the sludge during the settling stage for further treatment. During the settling stage, activated sludge is allowed to settle under quiescent conditions. There is no influent entering the tank and no aeration or mixing takes place. The activated sludge tends to settle as a mass of flocs, forming an interface with the clear supernatant. Sometimes the sludge mass is referred to as a sludge blanket. The settling phase is an important part of the SBR cycle because if the solids do not settle rapidly, some sludge can be drawn off during the subsequent decant phase and this will degrade the quality of the effluent.

During the decanting phase, a decanter is used to remove the clear supernatant effluent. In some cases, a floating decanter is used. Floating decanters have an inlet orifice slightly below the water level to minimize the removal of solids in the effluent during the decant phase.

Many SBR processes rely on a single tank and activated sludge where the biomass is suspended in mixed liquor. These SBR designs have limited load capacity. In addition to the limited capacity of conventional SBR systems, there is a problem with many existing SBR systems in use today. Many existing SBR systems are operating at their designed capacity or near design capacity. There are few viable options for upgrading or expanding capacity without constructing additional reaction tanks or settling basins.

Therefore, there is a need to address the limited capacity of conventional SBR processes and, at the same time, provide a viable option to increase capacity of existing SBR units without requiring the construction of additional tanks.

### SUMMARY OF THE INVENTION

The present invention provides an integrated fixed film activated sludge (IFAS) sequencing batch reactor (SBR) process where both suspended biomass and biomass supported on biofilm carriers are utilized to biologically treat wastewater received by the SBR. In one embodiment, the SBR includes two hydraulically connected tanks with suspended biomass being contained in one tank and biomass supported on biofilm carriers in the other tank. The process is carried out such that the suspended biomass and biomass supported biofilm carriers are efficiently utilized to increase the capacity of the SBR.

Various processes, such as nitrification—de-nitrification, nitrification only, phosphorus removal, and BOD removal, can be carried out in the IFAS SBR. In any one of these processes, filling, settling and decanting of the two tanks can be carried out simultaneously. Furthermore, both tanks can be subjected to the reaction phase at the same time.

In another embodiment, ballast is added to one or more of the tanks to facilitate the settling of sludge during the settling phase. Flocs comprising biomass and other solids agglomerate around or attach to the ballast forming ballasted flocs. These relatively heavy ballasted flocs substantially increase the settling rate of the flocs.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of the IFAS sequencing batch reactor of the present invention.

FIG. 2 is a schematic illustration similar to FIG. 1 but showing a ballasted flocculation system incorporated into the IFAS sequencing batch reactor.

FIGS. 3A-3D are a sequence of views showing the basic phases of a process carried out with the IFAS sequencing batch reactor of the present invention.

### DESCRIPTION OF EXEMPLARY EMBODIMENTS OF THE PRESENT INVENTION

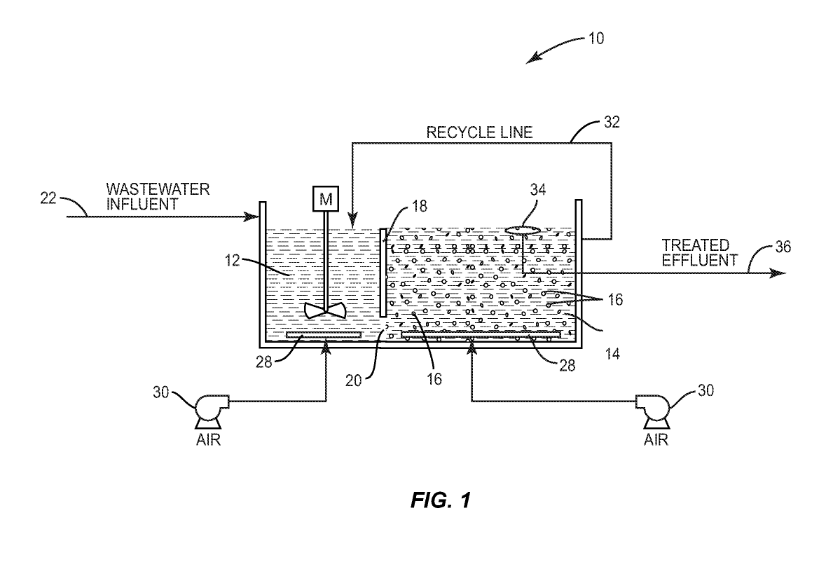

With further reference to the drawings, the IFAS sequencing batch reactor of the present invention is shown therein and indicated generally by the numeral 10. SBR 10 includes two tanks or basins, a first tank 12 and a second tank 14. Tanks 12 and 14 are separated by a wall 18. An opening 20 is provided in the wall 18 that enables tanks 12 and 14 to be hydraulically connected. In the embodiment illustrated in FIG. 1, opening 20 is disposed about the lower portion of the wall 18. In other embodiments, the height of opening 20 can be raised to various levels. For example, the opening 20 could be situated just above the top of the settled sludge layer.

Second tank 14 includes biofilm carriers or media 16. The media 16 could be the moving type or the fixed type. As those skilled in the art appreciate, biofilm carriers 16 support biomass that are effective in biologically treating the wastewater in tank 14. Details of the biofilm carriers 16 are not dealt with herein in detail because such is not per se material to the present invention. For a more detailed and unified understanding of biofilm carriers and their role in biologically treating wastewater, reference is made to U.S. Pat. No. 7,189,323, the disclosure of which is expressly incorporated herein by reference. In one embodiment, the first tank 12 is not provided with biofilm carriers 16 or any significant amount of biofilm carriers. In this embodiment, the SBR process described herein relies on suspended biomass to biologically treat the wastewater in the first tank 12. It should be pointed out that while there are biofilm carriers 16 in the second tank 14, the second tank would also typically include suspended biomass. In cases where it is desirable to only provide biofilm carriers 16 in a single tank, it is appreciated that some means is employed to retain the biofilm carriers in the tank and prohibit them from moving or migrating to the second tank. In the case of the embodiment shown in FIG. 1, the opening 20 is provided with a screen whose openings are sufficiently small to enable wastewater to pass therethrough but yet retain the biofilm carriers.

Both tanks 12 and 14 of the SBR 10 include the capability to aerate the wastewater therein. As seen in FIG. 1, both tanks are provided with an air diffuser 28 disposed in the lower portion of each tank. There is provided, in one embodiment, a pair of blowers 30 for directing air into the air diffusers 28. It should be pointed out that in some wastewater treatment processes there is no air supplied to a particular tank. Thus, the SBR 10 is provided with means to selectively control the aeration to each tank 12 and 14. In the case of the example shown in FIG. 1, there is provided two blowers 30 for directing air to the respective diffusers 28. It should be noted that, in some embodiments, one blower could be used to direct air to one or both of the tanks 12 and 14 and in that approach, appropriate control means is provided to enable air to be selectively directed to either tank 12 or 14. It is appreciated that aerating the wastewater causes the wastewater to be mixed. In one embodiment, tank 12 is provided with a mechanical mixer that can be selectively turned on and off depending upon a particular process being operated.

In a typical application, wastewater to be treated by the SBR 10 is directed through an influent line 22 into the SBR 10. In the case of the embodiment illustrated herein, the influent line 22 is directed into the first tank 12.

In some processes, it is appropriate to recycle wastewater from one tank to another tank. In the FIG. 1 example, there is provided a recycle line 32 that extends from the second tank 14 to the first tank 12. Thus, wastewater in tank 14 can be recycled to tank 12.

SBR 10 is also provided with a decanting device. The decanting device may be provided or designed so as to decant from both tanks 10 and 12 simultaneously. However, because of the opening 20 in wall 18 and the fact that the tanks 12 and 14 are hydraulically connected, a decanting device provided in one tank may be sufficient to decant treated wastewater from both tanks. In the example illustrated herein, there is a single decanting device provided in the second tank 14. This decanting device includes a floating inlet 34 that is coupled to an effluent line 36. During the decanting phase, treated wastewater enters the floating inlet 34 and is directed therefrom through the effluent line 36 and out the SBR 10.

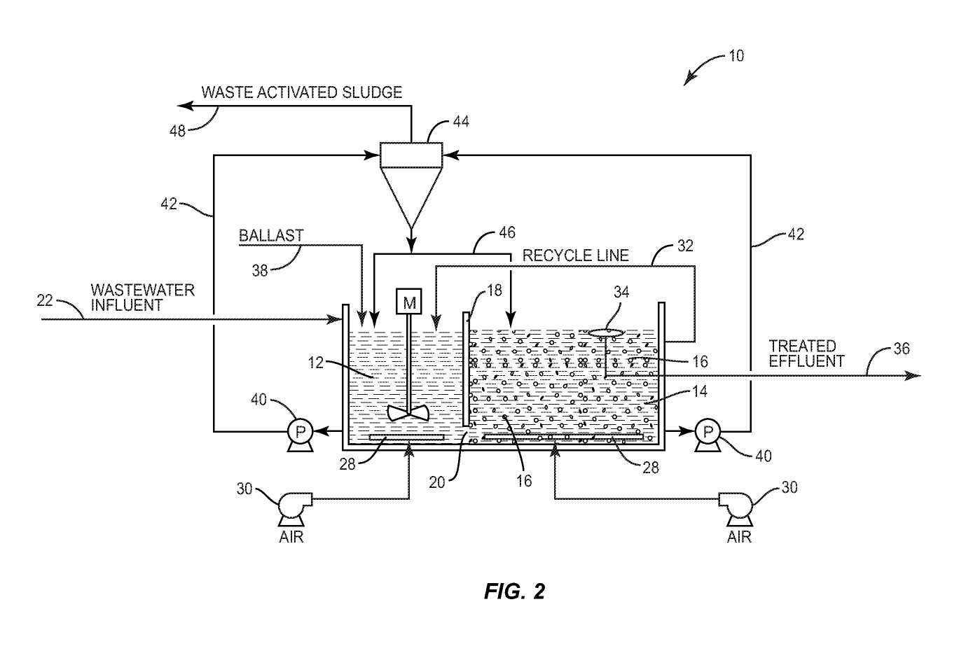

FIG. 2 shows an alternate embodiment for the SBR 10 shown in FIG. 1 and discussed above. In the FIG. 2 embodiment, the SBR 10 is provided with a ballasted flocculation system to facilitate and enhance the settling speed of flocs formed during a process. The ballasted flocculation system functions to inject a ballast into the wastewater. The ballast typically includes inert granular particles such as microsand. As is appreciated by those skilled in the art, flocs agglomerate or attach to the ballast and, because of the weight of the ballast, the flocs tend to settle faster than conventional settling processes.

Viewing the ballasted flocculation system shown in FIG. 2, it is seen that there is a ballast inlet 38 associated with the SBR 10. Fresh ballast is directed through ballast inlet 38 into one of the tanks of the SBR 10. Ballasted flocs, during the settling phase, settle in the tanks 12 and 14 and form a sludge layer. The sludge including the ballasted flocs is pumped from the SBR 10 by pump 40 through a sludge line 42 to a solids separator. In one example, the solids separator is a hydrocyclone 44. Hydrocyclone 44 separates the ballast from the sludge and directs the separated ballast back into the SBR 10 via the recycle ballast lines 46. In the example shown in FIG. 2, recycled ballast is directed back into both tanks 12 and 14. It is understood that, in many cases, it is sufficient to simply recycle the ballast back to one of the tanks. Sludge separated from the ballast by the hydrocyclone can be wasted and/or further treated.

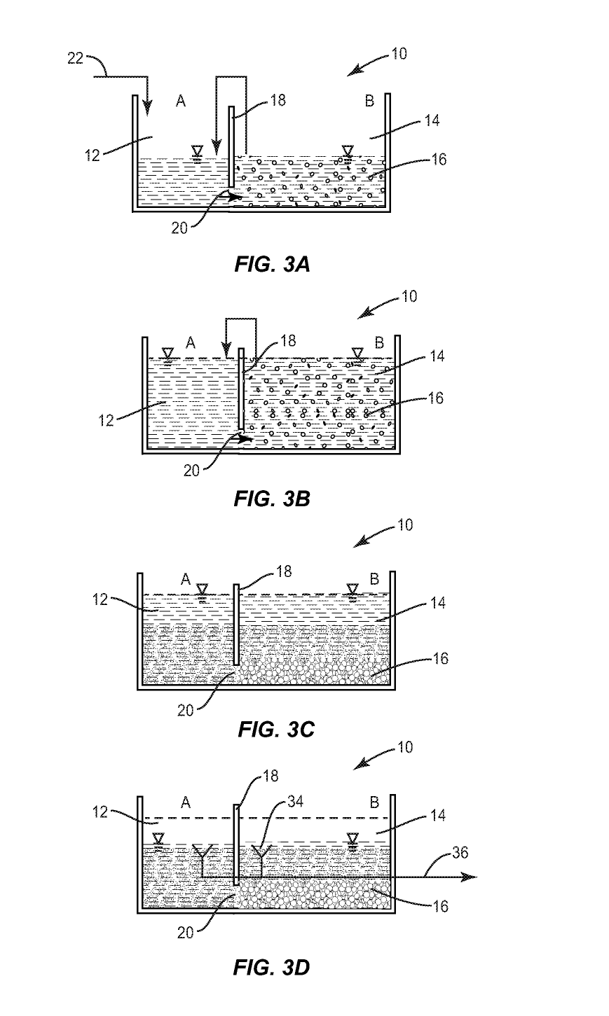

Turning to FIGS. 3A-3D, a typical SBR process is shown therein and particularly illustrates four basic phases of an SBR process: (1) fill, (2) react, (3) settling and (4) decanting. FIG. 3A shows the fill phase. Wastewater is pumped into tank 12. Wastewater passes from tank 12 through opening 20 in the wall 18 and flows into tank 14. The level of wastewater in tanks 12 and 14 is typically the same. During the filling phase, wastewater in both tanks 12 and 14 rise together. A control valve associated with the decanting device is closed and aeration of the tanks can be on or off. As will be discussed later, biological treatment of the wastewater can commence during the filling phase.

After the filling phase, the SBR 10 is operated in a react phase. See FIG. 3B. This is the phase of the process where the wastewater is biologically treated. For example, as discussed subsequently herein, the SBR 10 can be employed to perform a nitrification/de-nitrification process or a nitrification process only. In both cases, BOD can be removed from the wastewater. During the react phase, the decant valve is closed and either tank 12 or 14 can be provided with aeration.

After the react phase, the SBR 10 is operated in a settling phase. Mixing and aeration are off and the decant valve is closed. Biofilm carriers 16 are relatively heavy, that is they are of the sinking type and they settle along with the suspended biomass. As shown in FIG. 3C, the biofilm carriers 16 in tank 14 settle on the bottom of tank 14. A sludge layer comprising flocs forms above the settled biofilm carriers 16. In a typical process, the sludge layer and settled biofilm carriers 16 will occupy approximately 50-75% of the volume of tank 14. The sludge layer alone in tank 12 in a typical process will occupy approximately 40-70% of the volume of tank 1. Because the SBR tank is usually relatively large, the media percentage fill should generally not exceed 30%. Typically, the percentage fill for the media should be approximately 10% to approximately 20%.

FIG. 3D illustrates the decanting phase. Mixing and aeration are off and the decanting valve is open. In this embodiment, the floating inlet 34 is disposed in the second tank 14 and the treated supernatant, shown in FIG. 3C, is decanted. In some cases, both tanks 12 and 14 can be decanted simultaneously by employing a floating inlet and an effluent line in both tanks 12 and 14. Generally, it is believed that decanting from one tank is effective to provide for the withdrawal of treated wastewater from both tanks.

As discussed above, the SBR 10 can be used to perform various biological wastewater treatments such as nitrification/de-nitrification and nitrification only. It may be useful to review how the SBR 10 performs a nitrification/de-nitrification process. In this case, suspended biomass is maintained in tank 12. Both biofilm carriers 16 and suspended biomass are maintained in tank 14. Fixed biomass is supported on biofilm carriers 16. During the filling phase, wastewater is directed into tank 12 and from tank 12 the wastewater moves through opening 20 into tank 14. There is no supplied air in tank 12 while tank 14 is aerated. Generally, tank 12 is maintained under anoxic conditions while tank 14 is maintained under aerobic conditions. It should be pointed out that during the filling process the BOD or a substantial portion of the BOD in the wastewater being directed into tank 12 is removed during the filling process. Normally in some embodiments at least 30% of the BOD is removed from the wastewater prior to reaching the second tank 14. Typically approximately 30% to approximately 50% of the BOD is removed prior to reaching the second tank 14. Generally, all or substantially all of the readily biodegradable COD is removed in the first tank 12 prior to the wastewater reaching the second tank 14. The reduction of BOD concentration and the removal of readily biodegradable COD can be achieved with a relatively small volume. For example, in one embodiment, the volume of the first tank 12 can be 10-30% of the total volume of the reactor. The significance of this will be discussed later. Thus, even during the filling phase, tank 14 performs a nitrification process. That is, ammonia in the wastewater in tank 14 is converted to nitrate and nitrite by the biomass in tank 14. A substantial portion of the nitrification process is carried out by the biomass supported on barriers 16 as this biomass is particularly efficient in a nitrification process. Tank 12, which is operated under anoxic conditions even during the filling phase, performs denitrification; that is, the suspended biomass in tank 12 converts the nitrate and nitrite to nitrogen gas. This results because a portion of the wastewater nitrified in tank 14 is recycled via line 32 from the second tank 14 to the first tank 12. This basic nitrification and de-nitrification process using an integrated fixed film activated sludge process is extended into the react phase. As occurred during filling, in the react phase the biomass supported on the biofilm carriers 16 in the second tank 14 perform a nitrification process and a portion of the wastewater that has been nitrified in tank 14 is recycled to tank 12, which is operated under anoxic conditions and which de-nitrifies the wastewater therein.

After the react phase, the SBR 10 is operated in the settling and decanting mode as discussed above. In a nitrification/de-nitrification process, it may be advantageous to design the process such that all or a substantial portion of the BOD (meaning at least approximately 30% of the BOD in the influent) is removed from the wastewater before entry into the nitrification tank 14. This tends to enable the autotrophic microorganisms to proliferate and dominate and hence improve overall nitrification efficiency. Thus, in the exemplary nitrification/de-nitrification process described above, it is advantageous to remove the BOD in the wastewater in tank 12 before the wastewater reaches the nitrification tank 14.

Although the schematic illustrations suggest that tanks 12 and 14 include a generally equal volume, it should be pointed out that in some processes one tank may have a greater volume than the other. For example, in the nitrification/de-nitrification process just described, it is contemplated that in some cases it is advantageous to provide the nitrification tank 14 with a greater volume than the first tank 12. This is because a greater volume may be required to efficiently nitrify than may be required to de-nitrify.

The SBR 10 can also remove phosphorus from the wastewater influent. For example, in the nitrification/de-nitrification process described above, tank 12 generally operates under anoxic conditions, meaning that there is nitrate and nitrite available to the microorganisms in the tank. However, the total process can be controlled such that the nitrite and nitrate in tank 12 can be depleted. When this occurs, tank 12 then begins to operate under anaerobic conditions which is suitable for phosphorus removal.

What has been described above is a two stage IFAS SBR. There are numerous advantages to the two stage IFAS SBR compared to a one stage conventional SBR. The following is a comparison of these two SBR systems for a nitrification only process and a nitrification/de-nitrification process.

Nitrification Only

Conventional SBR and two-stage IFAS SBR are designed to treat typical domestic sewage with following characteristics:
CBOD_{INF}=250 mg/L; TSS_{INF}=250 mg/L; TKN_{INF}=40 mg/L; T_{INF}=8° C.

The target effluent qualities are:
CBOD_{EFF}=10 mg/L; TSS_{EFF}=10 mg/L; NH4_{EFF}=1.0 mg/L; NO3_{EFF}=None

Conventional SBR for nitrification uses a single reactor with a single aerobic phase plus settling and decanting. The two-stage IFAS SBR uses two zones, both under aerobic conditions. The first zone is non-media, activated sludge only and the second zone is filled with biofilm carriers. The typical designs are summarized in Table I below to demonstrate the features of the two-stage IFAS system. The first zone of the IFAS SBR is sized to remove readily biodegradable organics in the influent, which will improve the ammonia surface removal rate on the biofilm carriers in the second zone.

TABLE I

| | One-stage | |
|---|---|---|
| | Conventional | Two-Stage |
| | SBR | IFAS SBR |
| Design Flow, MGD | 0.7 | 1.0 |
| Total Reactor Tank Volume, Mill. Gallon | 0.48 | 0.48 |
| Fraction of First Zone out of Total | NA | 0.15 |
| Hydraulic Retention Time, hour | 16.5 | 11.5 |
| Length of Total Cycle, T_{C}, hour | 6.0 | 4.0 |
| T_{C} = T_{P} + T_{S} + T_{D} | | |
| Length of Settling Phase, T_{S}, hour | 0.75 | 0.75 |
| Length of Decanting Phase, T_{D}, hour | 0.5 | 0.5 |
| Length of Process Phase, T_{P}, hour | 4.75 | 2.75 |
| T_{P} = T_{F} + T_{R} | | |
| Length of Fill phase, T_{F}, hour | 1 to 4.75 | 1 to 2.75 |
| Length of Reaction Phase, T_{R}, hour | 3.75 to 0.0 | 1.75 to 0.0 |
| SVI | 120 | 120 |
| MLSS at Top Water Level | 4100 | 3700 |
| Fraction of Second Zone | NA | 0.85 |
| Percent of Media Fill In the Second Zone, % | NA | 0.2 |
| Total Solids Retention Time, SRT_{T}, day | 12.3 | 8.0 |
| Process SRT, SRT_{P}, day | 9.7 | 5.5 |
| Oxic SRT, SRT_{Oxic}, day | 9.7 | 5.5 |
| Sludge Yield, lb-TSS/lb-BOD | 0.92 | 0.86 |
| Specific Oxygen Demand, lb-O2/lb-BOD | 1.48 | 1.38 |
| Recirculation Flow, % of influent | NA | 300% |
| Overall F/M Ratio, kg-BOD/kg-MLSS/d | 0.11 | 0.20 |

Nitrification/De-Nitrification

Conventional SBR and the two-stage IFAS SBR are designed to treat typical domestic sewage with following characteristics:
CBOD_{INF}=250 mg/L; TSS_{INF}=250 mg/L; TKN_{INF}=40 mg/L; T_{INF}=8° C.

The target effluent qualities are:
CBOD_{EFF}=10 mg/L; TSS_{EFF}=10 mg/L; NH4_{EFF}=1.0 mg/L; NO3_{EFF}=8.0 mg/L

Conventional SBR for nitrification and de-nitrification uses a single reactor with anoxic and oxic (aerobic) phases plus settling and decanting. The two-stage IFAS SBR uses the first zone under anoxic conditions and the second zone under aerobic or oxic conditions. The first zone is non-media, activated sludge only and the second zone is filled with biofilm carriers. The typical designs are summarized in Table II below to demonstrate the features of the two-stage IFAS system. The first zone of the IFAS SBR is sized to achieve the de-nitrification to meet the effluent nitrate requirement, which will improve the ammonia removal rate on the media carriers in the second zone.

TABLE II

| | One-stage | Two-Stage |
|---|---|---|
| | Conventional | IFAS |
| | SBR | SBR |
| Design Flow, MGD | 0.7 | 1.0 |
| Total Reactor Tank Volume, Mill. | 0.58 | 0.58 |
| Gallon | | |
| Fraction of First (Anoxic) Zone out | NA | 0.25 |
| of Total | | |
| Fraction of Anoxic phase out of Total | 0.25 | NA |
| Process | | |
| Hydraulic Retention Time, hour | 20.0 | 13.9 |
| Length of Total Cycle, T_{C}, hour | 6.0 | 6.0 |
| T_{C} = T_{P} + T_{S} + T_{D} | | |
| Length of Settling Phase, T_{S}, hour | 0.75 | 0.75 |
| Length of Decanting Phase, T_{D}, hour | 0.5 | 0.5 |
| Length of Process Phase, T_{P}, hour | 4.75 | 4.75 |
| T_{P} = T_{F} + T_{R} | | |
| Length of Fill phase, T_{F}, hour | 1 to 4.75 | 1 to 4.75 |
| Length of Reaction Phase, T_{R}, hour | 3.75 to 0 | 3.75 to 0 |
| SVI | 120 | 120 |
| MLSS During the Reaction Phase | 4467 | 3400 |
| Fraction of Second (Oxic) Zone | NA | 0.75 |
| Percent of Media Fill In the | NA | 10% |
| Second Zone, % | | |
| Total Solids Retention Time, SRT_{T}, day | 17 | 10.5 |
| Process SRT, SRT_{P}, day | 13.5 | 8.3 |
| Oxic SRT, SRT_{Oxic}, day | 10.1 | 6.2 |
| Sludge Yield, lb-TSS/lb-BOD | 0.87 | 0.76 |
| Recirculation Flow, % of influent | NA | 300% |
| R = Vo/V_{F} | 2.3 | NA |
| Overall F/M Ratio, kg-BOD/kg- | 0.085 | 0.16 |
| MLSS/d | | |

It should be pointed out that for a nitrification—de-nitrification application, a conventional SBR may have to increase total reactor volume to realize the recirculation rate required for de-nitrification (R=Vo/V_{F}=3 or 4). This means that a conventional SBR has to be operated at short cycle time. The IFAS SBR of the present invention with recirculation will eliminate this requirement. For more stringent effluent requirements, both a conventional SBR and an IFAS SBR as disclosed herein will operate at a short cycle. For this case, the IFAS SBR of the present invention will be more desirable than a conventional SBR.

The present invention also relates to retrofitting existing SBRs. As discussed above, many existing SBRs are at or near design capacity. These SBRs may include only one tank or, in some cases, the SBR could include multiple tanks. The present invention envisions segmenting these tanks and providing for an integrated fixed film activated sludge process to be performed in two tanks or tank pairs. That is, existing tanks would be provided with a wall that includes an opening therein that would effectively form two tanks or basins from a single tank or basin. One of the segmented tanks that is formed is designed specifically to contain biofilm carriers 16 while the other tank is designed to perform processes relying on suspended biomass. This will increase the efficiency of biological treatment in these existing SBRs without requiring new tanks to be constructed and without increasing the footprint of the SBRs. This is because the IFAS SBR process described herein has greater capacity to biologically treat wastewater on a unit area basis than conventional SBR processes.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of treating wastewater in an integrated fixed film activated sludge sequencing batch reactor having first and second hydraulically connected tanks, the method comprising:
filling the first and second tanks with the wastewater;
biologically treating the wastewater in the sequencing batch reactor employing an integrated fixed film activated sludge process including:
i. biologically treating the wastewater in the first tank with suspended biomass;
ii. biologically treating the wastewater in the second tank with biomass supported on moveable biofilm carriers contained in the second tank;
settling the suspended biomass and the biofilm carriers; and
decanting the wastewater in the first and second tanks of the sequencing batch reactor.

2. The method of claim 1 including simultaneously decanting treated wastewater from the first and second tanks.

3. The method of claim 1 wherein the biofilm carriers are contained in only the second tank of the sequencing batch reactor.

4. The method of claim 1 including:
denitrifying the wastewater in the first tank by employing the suspended biomass;
nitrifying the wastewater in the second tank by employing the biomass supported on the biofilm carriers and suspended biomass; and
recycling at least a portion of the wastewater in the second tank to the first tank.

5. The method of claim 1 including adding a ballast to the wastewater in the sequencing batch reactor and attaching suspended flocs in the wastewater to the ballast; and settling the ballast having the suspended flocs attached thereof.

6. The method of claim 1 including employing the suspended biomass in the first tank to remove BOD from the wastewater; and employing the biomass supported on the biofilm carriers and suspended biomass in the second tank to nitrify the wastewater.

7. The method of claim 1 including directing the wastewater to be treated into the first tank and directing the wastewater from the first tank to the second tank; and employing the suspended biomass in the first tank to remove at least 30% of the BOD in the wastewater before the wastewater reaches the second tank.

8. The method of claim 1 including filling, settling and decanting the first and second tanks simultaneously.

9. A method of increasing the load capacity of an existing sequencing batch reactor having at least one tank, comprising: segmenting the tank by splitting the tank into two zones separated by a wall that is inserted into the tank of the existing SBR and providing for the two zones to be hydraulically connected such that wastewater being treated can flow from one zone to another zone; configuring the two zones such that biofilm carriers can be placed in one zone and retained in the one zone and prohibited from moving into the other zone; and providing at least one decanting outlet for decanting both zones.

10. The method of claim 9 including providing at least one injection site for injecting ballast into at least one zone.

11. A method of treating wastewater in an integrated fixed film activated sludge (IFAS) sequencing batch reactor (SBR) having first and second tanks, the method comprising:
filling the tanks of the SBR with wastewater to be treated;
biologically treating the wastewater in the first tank with suspended biomass;
employing an IFAS biological process to treat the wastewater of the second tank wherein biomass supported on mobile biofilm carriers are utilized to treat the wastewater;
injecting a ballast into at least one of the tanks;
settling suspended flocs and the ballast in at least one of the tanks wherein at least some of the suspended flocs attach to the ballast which facilitates the settling rate of the flocs;
decanting the first and second tanks to remove treated wastewater therefrom; and
removing the ballast and attached suspended flocs from the one or more tanks and separating ballast from the suspended flocs and recycling at least a portion of the separated ballast to at least one of the tanks.

12. The method of claim 11 including simultaneously filling the two tanks of the SBR with wastewater to be treated and simultaneously decanting treated wastewater from both tanks.

13. The method of claim 11 including biologically denitrifying the wastewater in the first tank with the suspended biomass; nitrifying the wastewater in the second tank by employing the biomass supported on the biofilm carriers and suspended biomass; and recycling at least a portion of the wastewater from the second tank to the first tank.

14. The method of claim 11 wherein during filling of the SBR, the method includes operating the first tank under anoxic conditions and operating the second tank under aerobic conditions; and recycling at least some of the wastewater from the second tank to the first tank.

15. The method of claim 11 wherein settling is carried out in a settling phase, and the method includes injecting the ballast prior to initiating the settling phase.

16. The method of claim 11 wherein the moveable biofilm carriers are only contained in the second tank.

17. The method of claim 11 including removing the ballast from the one or more tanks of the reactor while decanting the treated wastewater.

18. A method of treating wastewater in an integrated fixed film activated sludge sequencing batch reactor having first and second tanks, comprising:
filling the tanks of the SBR with wastewater to be treated;
biologically treating the wastewater in the first tank with suspended biomass;
the second tank including moveable biofilm carriers having biomass supported therein, and the method includes treating the wastewater in the second tank with biomass supported on the biofilm carriers;
charging the first and second tanks with a ballast and wherein suspended biomass in the SBR attaches to the ballast;
settling the ballast and attached suspended biomass in the SBR;
decanting treated wastewater from the first and second tanks of the SBR; and
removing the ballast and attached suspended biomass from the SBR and separating the ballast from the suspended biomass and recycling at least a portion of the separated ballast to the SBR.

19. The method of claim 18 including simultaneously decanting wastewater from the first and second tanks and while decanting the wastewater removing at least some of the ballast and attached suspended biomass from the SBR.

20. The method of claim 18 including charging the first and second tanks with the ballast prior to settling.

21. The method of claim 18 including retaining the biofilm carriers in the second tank and preventing the biofilm carriers from moving into the first tank.

22. The method of claim 18 wherein the SBR is operated under conditions that nitrify and denitrify the wastewater and where the method includes operating the first tank under anoxic conditions such that the suspended biomass denitrifies the wastewater; and operating the second tank under aerobic conditions such that the biomass supported on the biofilm carriers and suspended biomass nitrify the wastewater therein; and recycling at least a portion of a wastewater from the second tank to the first tank.

23. An apparatus for treating wastewater comprising an integrated fixed film activated sludge sequencing batch reactor having first and second tanks; the first and second tanks separated by a wall; the first and second tanks being hydraulically connected; suspended biomass contained in the first tank; sinkable biofilm carriers contained in the second tank for supporting biomass; and an aeration device for aerating at least the second tank.

24. The apparatus of claim 23 including an opening in the wall for permitting the flow of wastewater between the first and second tanks.

25. The apparatus of claim 23 wherein the first tank is free of biofilm carriers.

26. The apparatus of claim 24 wherein there is provided a screen in the opening for prohibiting biofilm carriers in the second tank from moving into the first tank.

27. The apparatus of claim 23 including a ballasted flocculation system incorporated into the sequencing batch reactor for injecting ballast in the form of insoluble granular particles into the sequencing batch reactor in order to enhance the settling of flocs in the sequencing batch reactor.

28. The apparatus of claim 23 including a recycle line for recycling wastewater from the second tank to the first tank.
